(19) United States
(12) Patent Application Publication
(10) Pub. No.: US 2014/0121359 A1
(43) Pub. Date: May 1, 2014

(54) PH-INDUCED FRACTIONATION PROCESSES FOR RECOVERY OF LIGNIN

(71) Applicants: John C. Blackburn, Easley, SC (US); Michael A. Lake, Mt. Pleasant, SC (US); Mark C. Thies, Clemson, SC (US); Julian Velez-Guillen, Clemson, SC (US)

(72) Inventors: Mark C. Thies, Clemson, SC (US); Julian Velez-Guillen, Clemson, SC (US); John C. Blackburn, Easley, SC (US); Michael A. Lake, Mt. Pleasant, SC (US)

(21) Appl. No.: 14/066,985

(22) Filed: Oct. 30, 2013

Related U.S. Application Data
(60) Provisional application No. 61/720,178, filed on Oct. 30, 2012.

(51) Int. Cl. C07G 1/00

(52) U.S. Cl. CPC C07G 1/00
USPC 530/500

(57) ABSTRACT

There are provided processes for recovering a “heart-cut” liquid-lignin fraction from a lignin-containing stream such as a black liquor stream from a paper making process or the crude lignin stream within a non-destructive biomass conversion process by carbonating, acidifying and recovering the liquid-lignin fraction. The processes generally include reacting black liquor with a carefully selected amount of carbon dioxide (CO₂), to decrementally reduce the pH of the black liquor and produce fractions of a dense liquid-lignin precipitate at each pH decrement to about a pH of 8. The sequential reduction in pH is less than or equal to about 1.5 in most embodiments, less than 1.0 in other embodiments, and less than 0.50 in still other embodiments. It has been discovered that lignin recovered from the dense liquid-lignin precipitate at the different pH decrements can have different molecular weight ranges and/or structures. This process provides an improved lignin with a more narrow distribution of molecular weight, melt point, and chemical structure that is more suitable for high-value polymer applications.

### CROSS REFERENCE TO RELATED APPLICATIONS

The present application claims the benefit and priority to U.S. Provisional Application No. 61/720,178, filed on Oct. 30, 2012, incorporated herein by reference in its entirety.

### BACKGROUND

Lignin, a component of wood, is the second most abundant polymer in the world behind cellulose. Lignin is primarily recovered from the black liquor stream within pulp and paper mills, such as from the kraft pulping process. Black liquor is removed from the host paper mill's recovery system downstream of an efficiently-performing soap separator, since tall oil impurities are deleterious to the operation of the unit operations of the process and the downstream applications, especially the high-value applications other than fuel pellets. Additionally, crude lignin is a byproduct stream from the plethora of technologies using enzymes being developed which convert the cellulose in biomass to ethanol or other products. Those enzymes do not affect lignin which exits those processes in various forms, generally low in solids and with various pH depending on upstream treatments. Another technology for cellulosic conversion to sugars, without destroying the lignin, are the solvent techniques, such as that being developed by Renmatix, Inc. (Kennesaw Ga.) that uses near-critical water to hydrolyze the cellulose to sugars,

With its high energy density and variety of functional groups and structure, lignin holds promise to be an efficient bio fuel source or green-chemical precursor. Thus, one use for lignin is to recover lignin as a solid and burn the solid lignin as a fuel, to or use the lignin as a binder for energy pellets. Another use is to provide a process to recover a high-purity low-salt lignin that is used to replace phenol used in resins for composites, to be a natural polymer for making polyurethanes, or to be used in a wide variety of alternative downstream chemical applications.

Currently wood pellets are burned, but the ash content and lower energy density limit their use as a fuel. Lignin pellets have approximately the same energy content as coal, about 12,000 Btu/lb, which is about 50% higher energy per mass of low-moisture wood pellets having about 8,000 Btu/lb. Lignin pellets may be used alone or blended directly with the coal feed with the only additional capital being the separate storage and feeding equipment for the pellets. Also lignin has demonstrated potential as an improved binder for wood or grass pellets, decreasing the dust levels generated in processing of the pellets, improving the water resistance of pellets which is important for outside storage of pellets, and increasing the energy density of the pellets.

Two lignin recovery methods from papermaking black liquor are presently used. The first method, implemented in the 1940s adjacent to a host kraft mill in Charleston S.C., makes powdered lignin containing high-salt content, which is difficult for power companies to handle. The salt content also creates issues with high ash within power furnaces. A bigger issue is that the impurities, including the salt, make this lignin unsuitable for downstream high-value applications such as polymers. Also there is the problem of cooling and diluting the black liquor that is returned to the host paper mills, which creates a high energy penalty in the black liquor recovery operation. The second method, in development since the 1990s, is currently run as a demonstration plant in Sweden and a commercial facility in North Carolina. This second method makes low-salt lignin pellets used for fuel, but major issues exist with high wash-water and energy penalty suffered by the host paper mills. The filtrates from the second method have to be returned to the host paper mill to recover the sodium but the black liquor is cooled significantly (from >200° F. to <140° F.) in addition to the wash water, which is added.

Removing a fraction (up to 30%) of the lignin from black liquor allows pulp and paper mills that have reached the maximum throughput of their recovery boilers to increase production by the same fraction of lignin removed. This is important, because although the worldwide paper production has decreased, the small inefficient mills have gone out-of-business, whereas the larger more efficient mills have increased production. Typically, a mill will increase its production of pulp and/or paper until the limit of the recovery boiler has been reached. Many of these mills have reached the limit of their boilers because of heat-transfer limitations. The multiple tubes within the furnace that generate high-pressure steam on the inside with heat transferred from the burning concentrated black liquor on the outside reach their upper limit of heat flux. Increasing that heat flux risks catastrophic consequences (recovery furnace explosions); thus mills don't exceed that limit. Removing a fraction (30%) of the lignin allows the mills to increase their overall production rate of paper by that same fraction.

Also, the green house gas emissions for a mill can be reduced significantly by removing lignin. For example, a large paper mill recovering 30% of their lignin from black liquor could produce >50,000 tons of lignin per year. Most pulp and paper mills have the infrastructure to gather residual wood within an economically-effective radius (˜70 miles) of the mill. If a papermaking facility makes 50,000 ton/yr of lignin, and that lignin energy value is replaced by burning residual wood, then that lignin is used to displace coal, then the overall green-house gases are reduced by 125,000 ton/yr.

The recovery boiler is the single highest capital investment of all the operations within a pulp and paper mill. The recovery boiler can be retrofitted to increase its capacity, but this cost well over $100 million and requires months of downtime. In order to keep the mill running, black liquor has to be exported to a sister mill which will process the black liquor in its own recovery boiler system, returning white liquor to the mill. White liquor contains the sodium hydroxide and sodium hydrosulfide which are the catalysts for kraft pulping. A lignin-recovery process can be added onto existing operations, with zero or minimal downtime, and for much less capital than a Recovery Boiler retrofit.

Many states are implementing renewable energy thresholds on electricity-generating power furnaces, many of which burn coal. However, burning significant fractions of residual wood, as the paper industry does, requires a different design of the furnace, which would have a larger footprint and would require more capital than a coal-burning furnace. A major factor is the lower energy content of residual wood containing significant levels of water (40%); wet residual wood has as low as 25% the energy density (Btu/lb) as coal or lignin pellets. To produce energy pellets, the wood has to be dried to moisture contents of 10-20%, but still the energy density of cellulose is still % that of coal. And residual wood contains significant levels of inorganics, which result in much higher levels of ash within the fuel, which requires either specialized equipment to continuously remove the ash or periodic shut-down to remove the ash. The paper industry historically has built power furnaces capable of burning large fractions of residual wood; the power industry has not. The power industry can add small fractions of residual wood to their furnaces, but a practical upper limit is soon reached. Additionally the power industry and paper industry are frequently at odds, competing for the same supply of residual wood.

The lignin-recovery technologies practiced today precipitate lignin by reducing the pH of black liquor in a single step from its original pH of 13-14 down to a pH of 9-10. The lignin precipitated has a wide range of molecular weights, melting points, and functional-group distributions, mainly the phenolic and carboxylic structures on the backbone of the lignin. For many high-value applications, a more narrow distribution is desired. These applications include polymer applications and lignin fibers, which are precursors to carbon fibers.

### SUMMARY OF THE INVENTION

In accordance with the present disclosure there are provided processes for recovering lignin from papermaking black liquor to form a liquid-lignin phase or the crude lignin stream within an enzymatic biomass conversion process. In one embodiment, the process for recovering lignin from papermaking black liquor comprises decrementally reducing a pH of the black liquor by reacting the black liquor with an amount of carbon dioxide effective to reduce the pH by a pH decrement of less than or equal to 1.5, wherein reacting the black liquor with the carbon dioxide is under pressure, and at an elevated temperature to produce a dense liquid-lignin precipitate and a black liquor light phase with a reduced pH; isolating the dense liquid-lignin precipitate; and recovering lignin from the dense liquid-lignin precipitate, wherein decrementally reducing the pH of the black liquor with the carbon dioxide is repeated to produce at least one additional dense liquid-lignin precipitate.

In another embodiment, a process for recovering lignin fractions from kraft black liquor at an initial pH of greater than 12 comprises reacting the black liquor with carbon dioxide at a pressure within a range of 50 to 200 psig and a temperature within a range of 80° C. to 200° C.; wherein the carbon dioxide is in an amount effective to reduce the initial pH by a decrement of less than or equal to 3, and wherein reacting the black liquor with the carbon dioxide produces a black liquor light phase at the decrementally reduced pH and a first fraction of a dense liquid-lignin phase; recovering lignin from the first fraction; producing at least one additional fraction by repeating the step of reacting with the black liquor light phase at the decrementally reduced pH to reduce the pH by an additional decrement of less than or equal to 1.5; and recovering lignin from the at least one additional fraction.

The disclosure may be understood more readily by reference to the following detailed description of the various features of the disclosure and the examples included therein.

### BRIEF DESCRIPTION OF THE SEVERAL VIEWS OF THE DRAWINGS

Having described the invention in general terms, reference will now be made to the accompanying drawings, which are not necessarily drawn to scale, and wherein:

FIG. 1 is a schematic flow diagram which illustrates an embodiment of the process of the present disclosure showing the optional oxygenating step, the carbonating step, the acidifying step and the extracting step;

FIG. 2 is a schematic diagram of an alternative embodiment of the process of the present disclosure showing the application of oxygenating after the carbonating step;

FIG. 3 is a schematic flow diagram which illustrates an embodiment of the process of the present disclosure showing a continuous configuration for extraction of each fraction of liquid-lignin precipitate; and

FIG. 4 graphically illustrates pH as a function of total CO2 volume added in decrements to the black liquor.

### DESCRIPTION OF THE PREFERRED EMBODIMENT(S)

Disclosed herein are processes for recovery of lignin. The processes generally include pH-based fractionation of lignin from black liquor or the crude lignin stream within an enzymatic biomass conversion process, wherein fractions of lignin-rich liquid are precipitated by decremental pH reduction with compressed CO₂ at an elevated temperature and under pressure. The lignin-rich liquid fractions may then be further processed to provide a low ash dried lignin product, wherein each fraction may be of a different molecular weight and/or structure. As used herein, the term “low ash” generally refers to an ash content in the dried lignin of less than 1.0%.

Using black liquor as an example, the black liquor from a paper mill typically has an initial pH of about 13.5 to 14. The pH of the black liquor can be decrementally reduced to a pH of about 8 by reaction with CO₂ gas in an amount effective to produce the desired decrement. Once at this lower pH of about 8, a portion of the sodium and related cations from the papermaking process are displaced from lignin by acidification, which, depending on the acid, can form sulfate salts in the light (top) phase.

In most embodiments, the pH-based fractionation process includes reacting the black liquor with CO₂ at an elevated temperature and under pressure, wherein the CO₂ is in an amount effective to provide decrements of less than or equal to about 3 to a pH of about 8; in other embodiments, the pH-based fractionation process includes decrements of less than or equal to about 1.5 to a pH of about 8; and in still other embodiments, the pH-based fractionation process includes decrements of less than or equal to about 1.0 to a pH of about 8. In yet other embodiments, the pH-based fractionation process includes decrements of less than or equal to about 0.5 to a pH of about 8.

Each decrement step may be about equal or made to be markedly different by controlling the amount of CO₂ reacted with the sodium hydroxide and other basic components in the black liquor as may be desired depending on the application. When the decrements are markedly different, the initial decrement, for example, can be less than a decrement of 3 followed by one or more narrower decrements such as, for example, of less than 1, wherein each subsequent decrement may be equal or markedly different relative to the preceding decrement. For example, it has been discovered that 90% of lignin precipitation occurs at a pH range of 11.6 to 10.0. Using pH fractionation techniques taught by this application allows a “heart cut” of lignin to be produced with more narrow molecular-weight and/or functional group distributions. The remaining fractions of the lignin, which could be as little as 10% of the total lignin, would be returned to the host pulp mill where that fraction would be burned for its fuel value as currently done with all the lignin. At each pH decrement, the lignin precipitation provides a dense lignin-rich liquid that phase separates due to its higher specific gravity from the black liquor, i.e., a lighter less dense phase. Because of this, in some instances it may be desirable to reduce the pH of the black liquor from an initial value of about 13.5 to about 12 or 11 followed by relatively narrower pH decrements. After each decrement, the black liquor separates into the light (top) phase and the dense liquid-lignin phase (i.e., precipitated lignin), wherein the dense liquid-lignin phase is separated from the light (top) phase. The light phase with the lower pH (compared to the initial black liquor solution) is then recycled and reacted with CO₂ in an amount effective to further reduce the pH to a desired decrement and provide an additional dense liquid-lignin phase fraction. The dense liquid-lignin phase may then be flashed, acidified and washed to provide a solid lignin product exhibiting low ash content.

The pH-based fractionation process can be used to provide lignin-rich fractions with different molecular weights and/or different molecular structures. As will be discussed in greater detail herein, fractions of precipitated liquid-lignin obtained at higher pHs generally have higher molecular weights and a lower phenolic content. For example, black liquor at a pH of 14 is an aqueous mixture including lignin, various hemicelluloses, alkali, and water. Even though lignin structurally has a non-polar backbone, lignin remains in solution at the higher pHs because the carboxylic and phenolic functionalities present in lignin are largely present in their salt or sulfonated forms. By acidifying the black liquor solution by reaction with a controlled amount of CO₂, the ionized functional groups are converted back to their respective acid forms, which significantly reduce solubility. As the solution becomes less and less basic, the solubility of lignin decreases further to produce the liquid-lignin rich phase.

To better understand the physical phenomenon driving the liquid-liquid precipitation step, consider the following lignin structures I(a)-(c) and their corresponding pKa's.

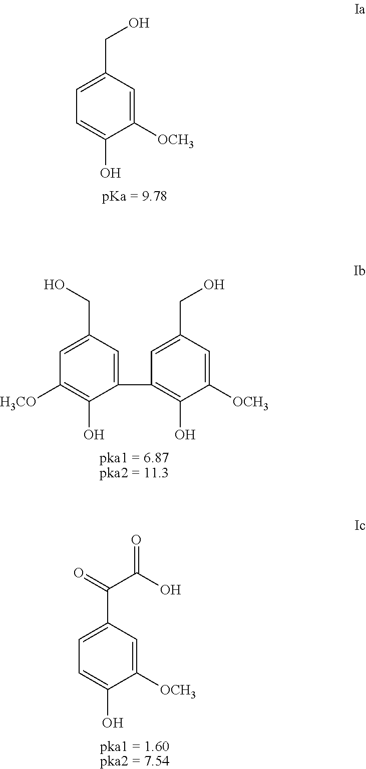

By acidifying the black liquor with CO₂, the ionized functional groups are converted back to their respective acid forms, significantly reducing their solubility in the solution and effecting precipitation. As the solution becomes less and less basic through the addition of CO₂, the solubility of lignin in the black liquor further decreases, producing more precipitation. Both lignin molecular weight and chemical functionality affect the solubility of a lignin species in the black-liquor phase as its pH declines. For example, consider the monomer vanillyl alcohol (Ia), which has a pKa of 9.78 as noted above. The pKa's listed below each lignin moiety are an approximate indication of the pH at which that moiety would tend to precipitate out of solution, all other factors being equal. Based on the pKa's, it can be expected that significant precipitation of the dimer of vanillyl alcohol, e.g., bi-vanillyl alcohol, which has a pKa of 11.3 for the 1^{st} phenolic group, will be observed at the higher pH decrement.

In view of the foregoing, similar behavior for other lignin moieties is expected, i.e., the monomers would not precipitate out of solution, as their pKa's generally occur at pH's below where most precipitation occurred in our carbonation process. However, the oligomeric forms would precipitate. On the other hand, the chemical functionality of the lignin moiety would also be expected to play a key role in precipitation behavior. For example, a derivative of vanillyl alcohol, αcarboxylvanillin (Ic) has a pKa for the phenolic group of only 7.54. This derivative (Ic) contains a carboxylic acid group, which strongly influences its pKa. Even in the oligomeric form, this molecule might not precipitate out of solution or would precipitate out only at the lowest pH's attainable with CO₂. Lignin as made by trees and other plants have a wide variety of these monomeric structures. This application shows how that distribution can be made more uniform to increase its value in downstream polymeric applications.

Once the precipitated liquid-lignin is isolated, it can be acidified with sulfuric acid in order to remove the salts (primarily sodium), thus converting most of the carboxylic and phenolic groups on the lignin molecules back to their acidified form. The acidification step can be performed by adding a strong protic acid (e.g., 1N sulfuric acid) to the vessel until the pH levels out at a value of about 2.5. The particular protic acid is not intended to be limited. For instance, organic acids such as formic or acetic acid could be used. Sulfuric acid is favorable since its cost is low and because the sulfur can be used in the host pulp mill to offset the normal sulfur make-up used by the mill to replace sulfur losses in the mill system, which produces internally the sodium hydrosulfide used as a pulping catalyst. Similar temperatures, pressures, and degree of agitation can be used for both the liquid-lignin precipitation step and acidification steps. The acidified lignin phase can then be allowed to settle out of solution, and the spent acid solution removed. The resultant acidified, liquid-lignin phase is an easy-to-handle, granular solid. The final step in the process is a water wash, whereby the acidified lignin from above is washed, with agitation, in the vessel with water at temperatures and pressures similar to what was used for the acidification step.

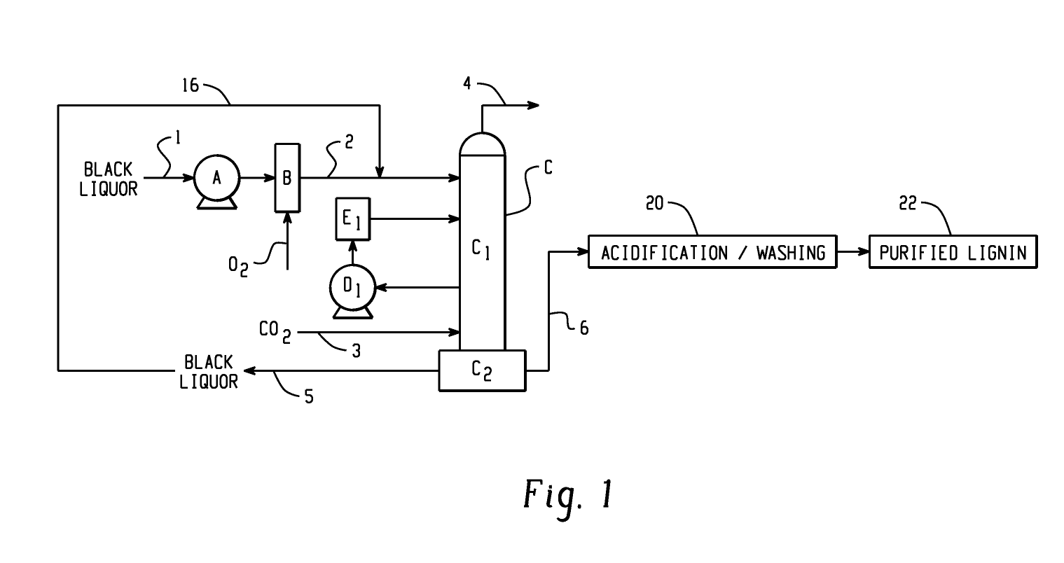

Referring now to FIG. 1, there is shown a schematic diagram depicting an exemplary pH-based fractionation batch process of the present disclosure showing the steps, from a lignin containing stream, of carbonating to form a liquid-lignin precipitate. Black liquor, leaving the soap separator in the pulp and paper plant, is introduced through line 1 to pump A where the black liquor is pressurized to between about 50 psig to about 200 psig, preferably about 150 psig. Typically, the black liquor is removed midway in the evaporator train, is preferably at a solids content of 30% to 45% and has a temperature of about 80° C. to about 120° C. Keeping the heat of reaction in the pressurized system raises the temperature significantly. It should be understood that the solids content of the black liquor ranges from about 10% to about 70% but more normally is from 25% to 60%. The melting point of lignin depends strongly on the level of sodium ions, the source of the lignin, and the level of occluded black liquor in the lignin phase, hence its viscosity is difficult to predict.

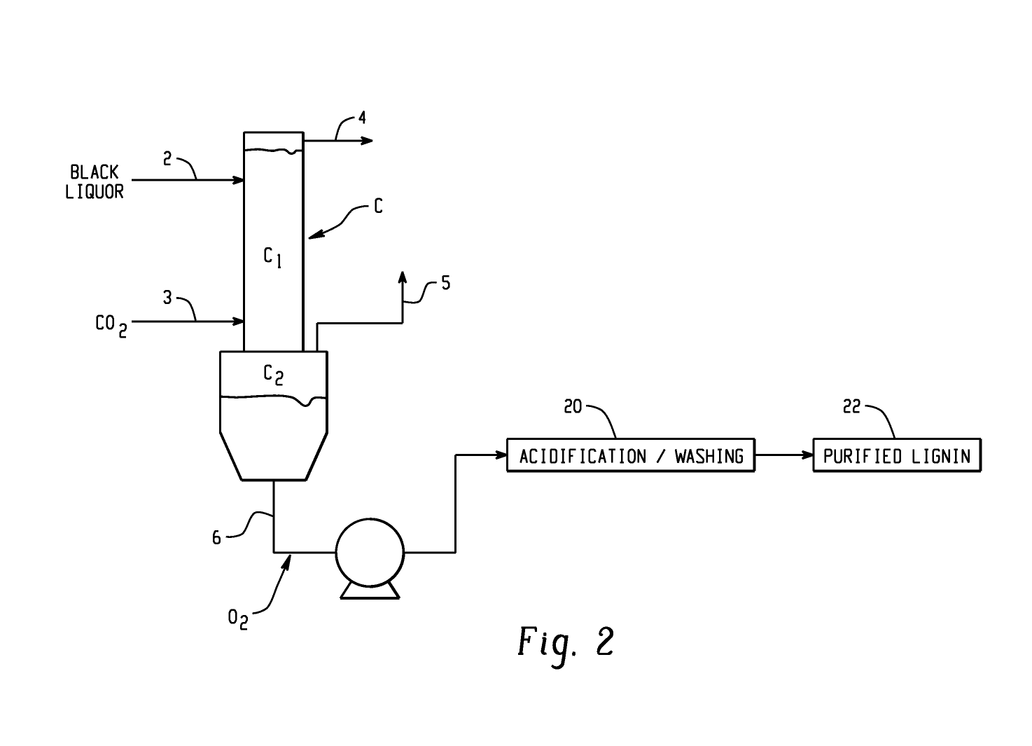

As an option, the pressurized black liquor may first be reacted with an oxidizing agent, such as oxygen, peroxide or the like, in an amount sufficient to reduce or eliminate the odor level in the black liquor so that there will be little or no odor in the final lignin product. Only the odorous materials are intended to be oxygenated, not the lignin material. This step removes the odor, by reaction with mercaptans (methyl, ethyl, dimethyl, and diethyl) and other malodorous components. Preferred equipment for this reaction is a Hydrodynamics Shockwave Power Reactor®, shown at B in FIG. 1. The oxygenation also has a substantial heat of reaction, raising the temperature of the stream about 50° C. depending on the reactants within the aqueous stream and its solids content. An alternative location in the process, that shown in FIG. 2, is to oxidize the liquid-lignin exiting the carbonation column C₂ in line 6, and thereby conserving oxygen by not oxidizing the entire black liquor flow. Another alternative is to not oxidize the black liquor when applications are insensitive to the odor of the final product, as typically would be the case when the lignin is to be used as a fuel or as a binder for energy pellets.

Pressurized black liquor is introduced via line 2 into the top of a two part CO₂ absorption column C. Compressed CO₂ is fed to the column C via line 3. The black liquor, with a high NaOH content and a pH of near 13-14, reacts with the CO₂ to form NaHCO₃/Na₂CO₃. The amount of CO₂ is controlled to provide the desired reduction in pH to the black liquor. The column operates at a nominal pressure of 50 to 200 psig and a temperature between about 80° C. and 200° C., preferably about 100° C. to 150° C. In the column, at least a portion of the NaOH is neutralized with the controlled amount of CO₂, thereby lowering the pH. Depending on the magnitude of desired pH reduction, the reaction can cause the release of a substantial exotherm, increasing the temperature of the stream depending on the NaOH content and the solids level of the stream. Malodorous gases leave the top portion C₁ of column C via line 4 and can be captured by a vent control system. When the option of oxygenating is used, the combined temperature rise of oxygenated and carbonated black liquor can be about 20° C. or more.

Lignin begins to precipitate immediately near the black liquor entrance near the top of the column C₁ as the pH begins to be reduced by introduction of carbon dioxide (CO₂) via line 3. As the pH decrementally decreases from its high (13-14) near the top to the exit at the bottom portion C₂ at pH 9-10, more and more lignin becomes insoluble and coalesces within column. The CO₂ preferably flows counter-currently, which creates a pH gradient in the column so that for each reduction in pH liquid-lignin droplets are created near the top that sweep and collect with other liquid-lignin droplets that are forming at the lower pH in the lower zone of the column. The liquid-lignin particles/droplets have a natural affinity for other liquid-lignin particles/droplets, facilitating coalescence as they fall within the column. As the dense liquid-lignin particles fall through the column, they collect with other particles that are forming at the lower pH within the lower zones of the column. The dense particles then coalesce into a bulk liquid-lignin phase, which accumulates at the bottom of the column. It is this bulk liquid-lignin phase that may then be acidified and washed to isolate solid lignin as will be described in greater detail below.

The black liquor and lignin solution pass into the bottom portion of the carbonation column C₂, where the precipitated liquid-lignin undergoes phase separation, forming a dense liquid-lignin phase and a light (top) phase (i.e., black liquor). The high temperature and pressure separation preserve heat from the heats of reaction of the sequential reaction of O₂, when the oxygenating step is used, and CO₂ that enables sending that heat back to the recovery operation in the black liquor. The lower portion C₂ of the CO₂ column is larger than the upper portion. The CO₂ also converts sodium (and other metals) and phenolic/carboxylic groups on the lignin molecules to the hydrogen form, causing the lignin to become insoluble. The light (top) phase (i.e., black liquor with reduced pH and less the lignin precipitated at the pH decrement) is fed back to the column C₁ via line 16 whereas the dense liquid-lignin phase leaves the bottom of the column C₂ via line 6 and is further processed.

A safety re-circulating loop can be provided within column C₁ to remove excess heat if needed. The loop includes pump D₁ and heat exchanger E₁. Alternatively, the temperature within the column can be controlled with a heat exchanger on the inlet black liquor line, controlling the temperature within the column to provide optimum separation.

The fractions of the liquid-lignin phase are then further processed. In one example, each liquid-lignin fraction is acidified with a strong acid as shown in step 20 to displace the sodium and other cations from the phenolic and carboxylic functionalities on the lignin backbone. This strong acid treatment also converts the lignin to a solid form, which can then be washed with water to remove the sodium (and other cations) salt to provide a low-ash lignin product, i.e., purified lignin 22.

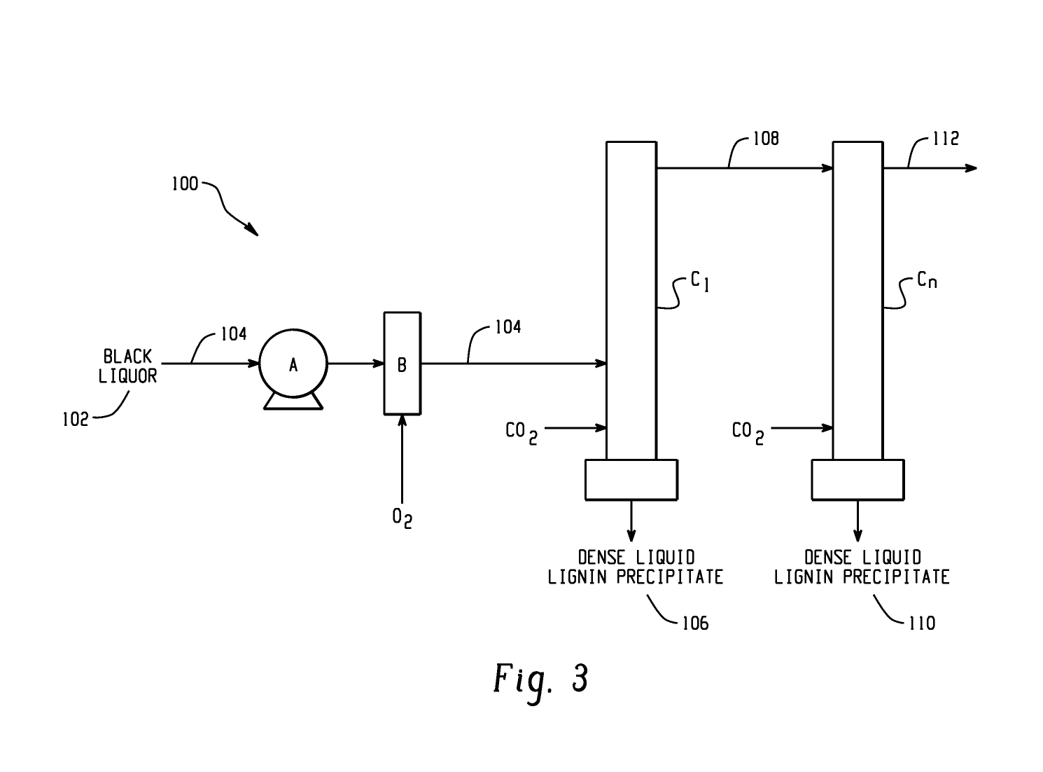

Turning now to FIG. 3 there is schematically depicted a continuous flow configuration 100 for pH-based fractionation of lignin. The continuous flow configuration includes a plurality of serially connected CO₂ absorption columns (C₁, . . . Cₙ), two of which are shown for clarity. However, it should be apparent that more than 2 can be provided depending on the number of fractions and pH decrements desired. A defined amount of black liquor 102 having a pH of about 13.5 to 14 (pH-initial) is fed via line 104 to pump A where the black liquor is pressurized to between about 30 psig to about 200 psig into the CO₂ absorption column C₁ and reacted with a controlled amount of CO₂ effective to reduce the pH to a desired decrement. The lignin in the black liquor generally has a wide range of molecular weights and varying structures. /

The spent black liquor is fed via line 108 to an additional CO₂ absorption column Cₙ. The black liquor at the reduced pH (pH-1) is introduced into the second column Cₙ and reacted with a controlled amount of CO₂ to provide a second liquid-lignin fraction 110 and spent black liquor at a further reduced pH (pH-2). By fractionating and isolating the liquid-lignin precipitate in this manner, a range of different cuts of lignin can be obtained. The liquid-lignin fractions contain only that lignin that precipitates at the relatively narrow pH range, which vary by molecular weight and/or structure. Each dense liquid-lignin fraction e.g., 106, 110, may then be processed as previously discussed in FIGS. 1-3 to provide a low ash lignin product, wherein each fraction is of a different molecular weight range and/or may be structurally different. After the lignin has been removed from the black liquor by carbonation to a pH of about 9, the lignin depleted black liquor may be returned to the host papermaker.

Optionally, the black liquor 102 may be reacted with an oxidizing agent at B as previously described in relation to FIG. 1 to reduce or eliminate the odor levels. Alternatively, the liquid-lignin precipitate obtained may be oxidized to reduce odor levels. Upon reduction of the pH of the black liquor, dense liquid-lignin 106 precipitates and is taken off

Optionally, instead of returning the depleted black liquor to the host papermaker, further liquid-lignin precipitate fractions may be obtained by use of a gas mixture of CO₂ and acetic acid (AcOH). Operating at an elevated temperature and elevated pressure can render the acetic acid soluble in the CO₂ rich gas phase, wherein the amounts can be controlled to provide the desired pH decrement. For example, 10 mol. percent or more of acetic acid can be made to dissolve in CO₂ at 150° C. and 150 bar. Alternatively, the spent black liquor at a pH of about 8 can be can be made to flow counter-currently with acetic acid in a separate low pressure column with the flow rate of acetic acid being used to control the pH and thus the extent of precipitation of the remaining lignin. Although reference has been made to acetic acid, other weak acids such as formic acid and the like may be used.

The following examples are presented for illustrative purposes only, and are not intended to limit the scope of the disclosure.

### EXAMPLE 1

In this example, a modified Parr reactor setup was used as the operating unit with a 2 liter (L) vessel. The vessel was charged with 1.8 liters (about 2200 g) of black liquor from a Kraft pulping process having a pH of about 13.6 and 42% solids. The vessel was closed, purged with nitrogen, and then brought to a temperature of 115° C. and pressure of 140 psig under agitation with a helical impeller at a rate of 60 rpm. Once the temperature was reached, the reactor pressure was adjusted to 75 psig, which is 50 psi above the vapor pressure of water. A flow of CO₂ at about 200 milliliters per minute (mL/min) was introduced into the vessel and a known volume of CO₂ was provided in about 15 minutes to hour timespan in order to reduce the pH by about 0.5 increments. Agitation was then stopped and the contents allowed to settle for one hour.

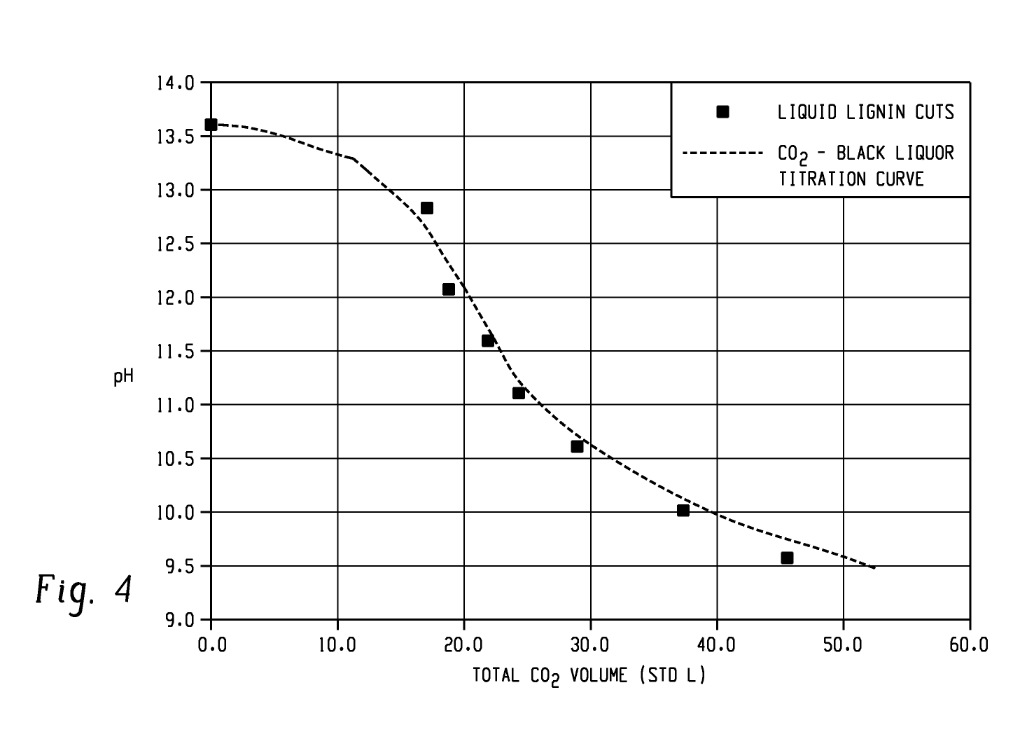

After the contents settled and cooled to about 65° C., the lighter black liquor was poured out of the vessel. The dense liquid-lignin phase or “cut” precipitated from the black liquor was collected after each pH decrement from the bottom of the vessel. The lighter black liquor was then recharged into the vessel and subject to carbonation as before to provide additional cuts of lignin. As shown in Table 1, the dense liquid-lignin that settled after about one hour was collected after each pH decrement as shown. Fractions 1, 2, 5, 6, and 7 are lignin fractions that precipitated as a liquid at 115° C. and solidified upon cooling. FIG. 4 graphically illustrates the reduction of pH as a function of the total CO₂ volume added for each decremental pH reduction.

TABLE 1

| | Final | Lignin-rich precipitate (grams)/100 | Solids | Ash¹ |
|---|---|---|---|---|
| Fraction No. | pH | grams of black liquor feed | (%) | (%) |
| Initial Feed | 13.6 | 0.00 | 42.0 | 47.4 |
| 1 | 12.8 | 0.10 | 62.1 | 31.5 |
| 2 | 12.1 | 0.06 | 67.7 | 28.1 |
| 3 | 11.6 | 0.37 | 62.1 | 22.1 |
| 4 | 11.1 | 4.15 | 57.1 | 27.8 |
| 5 | 10.6 | 4.61 | 50.1 | 22.3 |
| 6 | 10.0 | 2.60 | 60.8 | 25.0 |
| 7 | 9.5 | 0.58 | 58.1 | 27.6 |

¹Ash content on a dry basis

### EXAMPLE 2

In this example, softening point of the solvated liquid-lignin fractions obtained in Example 1 was measured. A variable-volume pressure-volume-temperature (PVT) cell was modified for softening point measurements of wet lignin fractions under pressure so that the lignin fractions did not lose water. The modification included a support made out of polytetrafluoroethylene (PTFE) designed to hold a Mettler cup and ball where the wet lignin was packed. The support was a 1⅛″ diameter PTFE disc with a ⅜″ hole for the Mettler cup and ball and a ˜0.5 ml water reservoir used to ensure a water saturated environment inside the cell when in use. The support was placed on top of a piston inn the PVT apparatus. Two legs support the bottom of the PTFE disc at ˜ 6/8″ from the floor of the piston so that the distance that the lignin fractions flow downwards before it was detected was comparable to that of standard methods that use the Mettler cup and ball apparatus (ASTM D6090).

A red laser pointing from the front of the view-slot of the PVT cell is lined up with a photoresistor placed in the back of the PVT cell. As the cell temperature increased, the lignin sample started to soften and drip down from the cup blocking the path of the laser beam and was detected as a change in resistance by the photoresistor. This change in resistance was recorded and related to the temperature of the cell at that point.

In a typical experiment, ˜0.5 g of wet, solid lignin was crushed using a mortar and pestle and then packed in the Mettler cup; the water reservoir in the PTFE support was filled with water, the ball was placed on top of the packed lignin and the PTFE support was placed on top of the piston and inside the cell. The piston was raised using the working fluid to flush as much air as possible and then water-saturated nitrogen was fed to the cylinder; the cell was flushed with nitrogen two times to ensure a nitrogen-rich environment and then the piston was moved up/down to pressurize the cell and to align the piston with the laser/photoresistor setup.

The oven was set to a temperature of 150° C., which provided a heating rate inside the cell of about 0.1-0.3° C./min. The pressure inside the cell was ˜70 psig when the set temperature had been reached, and the temperature inside the cell was measured with a resistance temperature detector (RTD) and recorded. The softening points of the lignin rich fractions were reproducible to within less than 0.5° C. Because the inner atmosphere of the PVT cell is replaced with water-saturated nitrogen, water does not escape from the lignin and the solids content of the solvated samples analyzed vary less than 2 percent before and after softening point measurement. The results are shown in Table 2.

TABLE 2
Lignin Fractions from pH-Fractionation and Their Softening Points

| Fraction No. | Final pH | Solvated Softening Point (° C.) |
|---|---|---|
| Unfractionated | 13.6 to 9.5 | 105.2 |
| 1 | 12.8 | 107.1 |
| 2 | 12.1 | 103.5 |
| 3 | 11.6 | 110.5 |
| 4 | 11.1 | 110.3 |
| 5 | 10.6 | 101.1 |
| 6 | 10.0 | 100.4 |
| 7 | 9.5 | 90.7 |

It should be noted that when the liquid-lignin fractions were dried at 105° C. to evaporate all of the water and the softening point measured for the dried product as is generally done in the prior art and in accordance with ASTM D6090 for measuring softening points of resins and as is typically practiced using a standard Mettler softening point apparatus, no softening of the dried lignin was observed for temperatures up to 375° C. In contrast, when solvated with water such as is the case when lignin precipitates from the aqueous black liquor solution as a result of the pH change, the softening point of the solvated liquid-lignin fractions were found to be below 115° C. as shown above suggesting that water acts as a plasticizer in the CO₂ precipitated lignin-rich fractions.

### EXAMPLE 3

In this example, inductively coupled plasma atomic emission spectroscopy (ICP-AES) was used in the determination of Na, K, and S in the spent black liquors and the precipitated lignin fractions. A dry sample of 0.1 g was pre-digested in 5 ml of concentrated nitric acid at ambient temperature for 30 minutes; then, digestion was started by heating to 125° C. for 90 minutes, continued by adding 3 ml of 30% hydrogen peroxide, and heating to 125° C. for one more hour. Once again, 3 more ml of hydrogen peroxide was added and the sample was kept at 125° C. for one more hour. Finally, the samples were heated to 200° C. for 1 more hour, which completed the drying process.

The dried samples were then diluted in 10 ml of 1.6M nitric acid and, after cooling, in another 50 ml of deionized water. The resulting liquid was then transferred to the ICP tube for analyses and detection. The results are shown in Table 3 below.

TABLE 3
Sodium, Potassium and Sulfur in Lignin Fractions

| Fraction | Final pH | Sodium | | Potassium | | Sulfur | |
|---|---|---|---|---|---|---|---|
| No. | Achieved | (%) | k_{Na}^{b} | (%) | k_{K}^{b} | (%) | k_{S}^{b} |
| 1 | 12.8 | 11.64 | 0.59 | 1.60 | 0.56 | 3.11 | 1.36 |
| 2 | 12.1 | 9.43 | 0.48 | 1.43 | 0.52 | 2.78 | 1.23 |
| 3 | 11.6 | 6.04 | 0.33 | 0.79 | 0.31 | 1.74 | 0.81 |
| 4 | 11.1 | 4.17 | 0.20 | 0.59 | 0.19 | 1.22 | 0.51 |
| 5 | 10.6 | 8.57 | 0.37 | 1.23 | 0.38 | 2.36 | 0.95 |
| 6 | 10.0 | 7.61 | 0.34 | 1.12 | 0.36 | 2.26 | 0.92 |
| 7 | 9.5 | 9.25 | 0.39 | 1.30 | 0.40 | 2.73 | 1.02 |

^{a}Percentage of elemental Na/K/S in the carbonated lignin fraction phase on a dry basis
^{b}kᵢ is the distribution ratio of component i in the liquid-lignin (LL) fraction vs. that in the accompanying spent black liquor (SBL) phase: kᵢ = x_{i,LL}/x_{i,SBL}

As demonstrated above, mass balances of sodium, potassium and sulfur in the partially spent black liquor phase and the liquid-lignin phase are close to about 90%. Table 3 also shows a distribution ratio kᵢ that is used to show the concentration of sodium, potassium and sulfur in the spent black liquor phase. kᵢ is defined as the concentration of component i in the liquid-lignin fraction versus that same component in the accompanying spent black liquor phase. For all fractions, a kᵢ<1 means that a lower concentration of these elements is found in the liquid-lignin phase compared to the spent black liquor phase. The lower metal content in fractions 3 and 4 determined by ICP-AES are in agreement with the lower ash content determined gravimetrically.

Advantageously, the process disclosed herein provides lignin with different molecular weights and/or structures that can be used for many different applications. For example, lignin pellets can be formed to replace coal in existing power furnaces. Alternatively, lignin in the form of randomly-shaped particles exits one of the embodiments of the process, saving the cost of extruder operation. The randomly-shaped particles or pellets of lignin may be used as an improved binder for the biomass-based energy pellet market.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A process for recovering lignin from papermaking black liquor, the process comprising: What is claimed is:
decrementally reducing a pH of the black liquor by reacting the black liquor with an amount of carbon dioxide effective to reduce the pH by a pH decrement of less than or equal to 1.5, wherein reacting the black liquor with the carbon dioxide is under pressure, and at an elevated temperature to produce a dense liquid-lignin precipitate and a black liquor light phase with a reduced pH; and
isolating the dense liquid-lignin precipitate; and
recovering lignin from the dense liquid-lignin precipitate,
wherein decrementally reducing the pH of the black liquor with the carbon dioxide is repeated to produce at least one additional dense liquid-lignin precipitate.

2. The process of claim 1, wherein the pH decrement is less than or equal to 1.0,

3. The process of claim 1, wherein the pH decrement is less than or equal to 0.5.

4. The process of claim 1 wherein the decrementally reducing the pH of the black liquor with the carbon dioxide is repeated until the pH of the black liquor is at about 8.

5. The process of claim 1, wherein decrementally reducing the pH of the black liquor with the carbon dioxide is a batch process.

6. The process of claim 1, wherein decrementally reducing the pH of the black liquor with the carbon dioxide is a continuous process.

7. The process of claim 1, wherein recovering the lignin from the dense liquid-lignin precipitate comprises:
acidifying the dense liquid-lignin precipitate to generate an acidified dense lignin phase;
recovering lignin from the acidified dense lignin phase;
washing extraction of the acidified dense lignin phase to remove residual acid and ash content, thereby generating purified lignin; and
recovering the purified lignin.

8. The process of claim 1, wherein reacting the black liquor with the amount of carbon dioxide is countercurrent to the black liquor

9. The process of claim 1, wherein reacting the black liquor with the amount of carbon dioxide is at a temperature between about 80° C. and about 200° C. and a pressure of 50 psig to about 200 psig.

10. The process of claim 1, wherein an oxidizing agent is reacted with the black liquor prior to reacting the black liquor with the amount of carbon dioxide, wherein the oxidizing agent is in an amount sufficient to eliminate or substantially reduce the odor of the resulting lignin product.

11. The process of claim 1, wherein an oxidizing agent is reacted with dense liquid-lignin precipitate in an amount sufficient to eliminate or substantially reduce the odor of the resulting lignin product.

12. The process of claim 7, wherein acidifying the dense liquid-lignin precipitate comprises mixing the dense liquid-lignin precipitate with a protic acid in an amount sufficient to reduce the pH to less than 4.

13. The process of claim 12, wherein the protic acid is sulfuric acid.

14. The process of claim 7, wherein acidifying the dense liquid-lignin precipitate comprises mixing the dense liquid-lignin precipitate with sulfuric acid in an amount sufficient to reduce the pH to between 1.5 and 3.5 at a temperature between about 100° C. and 130° C.

15. The process of claim 1, wherein vent gas generated during the step of acidifying the dense liquid-lignin precipitate to generate the acidified dense lignin phase is recycled to the step of decrementally reducing the pH of the black liquor.

16. The process of claim 1, wherein the papermaking black liquor is at a solids content between about 10% to about 70%.

17. The process of claim 1 wherein the black liquor feed from a papermaking operation is removed downstream of a tall oil soap separator.

18. The process of claim 1, wherein the lignin from step is shaped, including pelletizing.

19. The process of claim 1, wherein the dense liquid-lignin precipitate and the at least one additional dense liquid-lignin precipitate produce lignin having a different molecular weight range and/or structure.

20. The process of claim 1, wherein decrementally reducing the pH of the black liquor with the carbon dioxide is repeated to a pH about 8, wherein the process further comprises reacting the black liquor at the pH of about 8 with a combination of the carbon dioxide and acetic acid in amounts effective to reduce the pH by a pH decrement of less than or equal to 1.5 to form additional dense liquid-lignin precipitates.

21. A process for recovering lignin fractions from kraft black liquor at an initial pH of greater than 12, the process comprising:
reacting the black liquor with carbon dioxide at a pressure within a range of 50 to 200 psig and a temperature within a range of 80° C. to 200° C., wherein the carbon dioxide is in an amount effective to reduce the initial pH by a decrement of less than or equal to 3, and wherein reacting the black liquor with the carbon dioxide produces a black liquor light phase at the decrementally reduced pH and a first fraction of a dense liquid-lignin phase;
recovering lignin from the first fraction;
producing at least one additional fraction by repeating the step of reacting with the black liquor light phase at the decrementally reduced pH to reduce the pH by an additional decrement of less than or equal to 1.5; and
recovering lignin from the at least one additional fraction.

22. The process of claim 21, wherein the lignin from the first fraction has a different molecular weight distribution and/or chemical structure than the lignin from the at least one additional fraction.

23. The process of claim 21, wherein recovering the lignin from the first fraction or the at least one additional fraction comprises:
acidifying the first fraction or the at least one additional fraction to generate an acidified first fraction or an acidified at least one additional fraction;
recovering lignin from the acidified first fraction or the acidified at least one additional fraction;
washing the acidified first fraction or the acidified at least one additional fraction to remove residual acid and ash content, thereby generating purified lignin corresponding to the first fraction or the at least one additional fraction; and
recovering the purified lignin corresponding to the first fraction or the at least one additional fraction.

24. The process of claim 21, wherein the pH decrement is less than or equal to 1.0,

25. The process of claim 21, wherein the pH decrement is less than or equal to 0.5.

26. The process of claim 21, wherein repeating the step of reacting with the black liquor light phase at the decrementally reduced pH to reduce the pH by the additional decrement of less than or equal to 1.5 is to a pH of about 8 and further comprising reacting the black liquor at the pH of about 8 with a combination of the carbon dioxide and acetic acid in amounts effective to reduce the pH by a pH decrement of less than or equal to 1.5 to form additional dense liquid-lignin precipitates.

27. The process of claim 21 wherein an oxidizing agent is injected into said kraft black liquor prior to reacting the black liquor with the carbon dioxide and is in an amount sufficient to eliminate or substantially reduce the odor of the resulting lignin product.

28. The process of claim 21, wherein the additional decrement of less than or equal to 1.5 to the pH of about 8 are equal decrements.

29. The process of claim 21, wherein the additional decrement of less than or equal to 1.5 to the pH of about 8 are at different decrements.
